(19) United States
(12) Patent Application Publication
(10) Pub. No.: US 2023/0320468 A1
(43) Pub. Date: Oct. 12, 2023

(54) Touch Sensitive and Transparent Protective Cover for Handheld Electronic Devices

(71) Applicant: Janet Cochran, Alpine, CA (US)

(72) Inventor: Janet Cochran, Alpine, CA (US)

(21) Appl. No.: 17/835,259

(22) Filed: Jun. 8, 2022

Related U.S. Application Data
(60) Provisional application No. 63/329,005, filed on Apr. 8, 2022.

(51) Int. Cl. A45C 11/00; G06F 1/16; A45C 13/00

(52) U.S. Cl. CPC A45C 11/00; G06F 1/1656; A45C 13/002; G06F 2200/1633; A45C 2011/002; A45C 2200/10

(57) ABSTRACT

The present invention relates to a protective cover for cell phones, tablets, and other handheld electronics. The cover is configured to enclose an electronic device for protection against external elements, pathogens, and other contaminants. The cover is made of thin transparent plastic for viewing and using the touchscreen of the cover while the device is enclosed inside the cover. The cover slides over the device and has a closure at the base to secure the device inside the covering. The cover enables the users to use electronic devices including touchscreen, camera, and other features while the device is protected.

### CROSS-REFERENCE TO RELATED APPLICATION

The present application claims priority to, and the benefit of, U.S. Provisional Application No. 63/329,005, which was filed on Apr. 8, 2022 and is incorporated herein by reference in its entirety.

### FIELD OF THE INVENTION

The present invention relates generally to accessories for electronic devices. More specifically, the present invention relates to a novel, sleeve, bag or covering for electronic devices for preventing unwanted germs, bacteria, pathogens, dirt, sand and other debris from reaching and touching the surface of the device. The covering utilizes a touch sensitive and transparent plastic surface with a zippered closure at the base to secure a device inside the covering or sleeve. The covering allows an individual to use the device while the cover is placed over the device and prevents the transfer of germs, bacteria, and other pathogens from a user to the device and protects the individual using the device from contracting germs or other bacteria from the device. Accordingly, the present disclosure makes specific reference thereto. Nonetheless, it is to be appreciated that aspects of the present invention are also equally applicable to other like applications, devices, and methods of manufacture.

### BACKGROUND

By way of background, in recent years, handheld electronic devices, such as smart phones, tablets, PDAs, thermometers, scanners and other portable tools, have been widely used in daily life and in fact, have become necessary and a part of our lifestyle. Different hand tools, such as scanners, thermometers, and other medical equipment, are common during pandemics and are used in areas such as entrances to office buildings, airports, and other public areas to determine if an individual is exhibiting signs of an illness. Types and different functions of electronic devices are increasingly diversified and provide a wide gamut of uses. Electronic devices are more popular due to convenience, practicality and can be used for a multiple of purposes. Such handheld electronic devices are used by people of all ages and genders. Smartphones, tablets, and other devices are frequently used but infrequently cleaned and sanitized. In fact, studies have shown cell phones, tablets, and handheld and portable devices harbor infectious bacteria, including Streptococcus, Staphylococcus, E. coli, Enterococcus faecalis and MRSA. MRSA is an antibiotic-resistant pathogen and E. coli and Enterococcus faecalis bacteria are oftentimes present in fecal material and cause fever, diarrhea and nausea.

Smartphones, tablets, and other handheld and portable devices pick up dirt, bacteria, and germs from virtually any surface where they are placed or otherwise kept. Further, dirt, oil, and bacteria that all people have on their skin also collect on the handheld/portable electronic or other device. In many situations, cell phones can carry as many germs as a bathroom door handle or toilet seat. When individuals hold phones, tablets, and other devices near their face for use, bacteria and viruses can enter the nose and mouth and can cause minor and major diseases. In addition, bacteria and germs often come into contact with the skin of an individual and can lead to skin irritations, rashes, and other maladies. People desire a protective cover or sleeve that can prevent unwanted germs from touching the surface of cell phones, tablets, and other handheld electronics to prevent transferring germ and other contagions to an individual.

In situations where phones, tablets, and other commonly shared devices are passed between different people, each handheld electronic or other device can be a carrier for pathogens especially when a person encounters a communicable disease like COVID-19. Pathogens can be easily transmitted from one person to another by sharing handheld electronic and other portable devices. People with weaker immune systems may find themselves easily getting sick from common bacteria, viruses and germs found on portable devices such as cell phones. People desire an easily usable cover, sleeve, envelope, wrap and/or protective film for phones, tablets, and other handheld electronics and portable devices that can be easily used to cover such devices and can be removed easily for preventing transmission of germs between people.

Individuals can sanitize their phones, tablets, and other devices in order to clean and remove germs, however, such cleaning is rare and infrequent. Further, hard chemicals can damage the screen of a device as can moisture from the cleaning process. People as such, desire an easy-to-use cover that eliminates of the need to use a sanitizer or hard chemicals and/or exposes the device to moisture.

The cover is often used to protect the phone and other portable device from physical damage and to increase the aesthetic appeal of the device. However, such covers partially cover the device, typically, the rear surface and side surfaces, and the majority of the display remains open and accessible to germs. Further, the covers used in prior art solutions are generally not removed for a long time and can carry dirt and germs and as a result, are not useful in avoiding the transmission of germs, bacteria, pathogens, and other viruses. People also face the difficulty in operating their devices while the cover is on.

Therefore, there exists a long-felt need in the art for an improved protective covering for cell phones, tablets, handheld and portable devices and other electronics. There is also a long-felt need in the art for a multipurpose covering or sleeve for handheld electronic devices and portable devices that prevents unwanted germs from touching the surface of the electronic or other portable devices. Additionally, there is a long-felt need in the art for a cover or sleeve that protects handheld electronics from germs, while allowing individuals to use the electronics. Moreover, there is a long-felt need in the art for an improved protective covering or sleeve that eliminates the need to apply harsh cleaning chemicals to the electronic device and/or exposes the device to moisture during cleaning. Further, there is a long-felt need in the art for a protective cover or sleeve that completely encloses or envelopes a handheld electronic or other portable device for keeping the device clean and sanitary. Furthermore, there is a long-felt need in the art for a protective cover or sleeve for cell phones, tablets, and other electronics that prevents transmission of pathogens during the exchange or use of electronics between people. Finally, there is a long-felt need in the art for a protective covering that is transparent, does not interfere with the use of electronics, and protects the electronic or other device against external elements, bacteria, viruses, and other harmful pathogens.

The subject matter disclosed and claimed herein, in one embodiment thereof, comprises a touch sensitive and transparent protective cover or sleeve to protect a handheld electronic or other portable device from external elements, bacteria, viruses and other contaminants while using or not using the device. The protective cover or sleeve further includes a front layer that is configured to cover the touchscreen of the device, and a rear layer configured to cover the rear surface of the device. The cover has two closed side edges and a closed top edge. The front layer and the rear layer are releasably attached at the base of the cover. The base has a zippered closure disposed thereon for releasably fastening the cover over the device. The cover is configured to slide over the device to enclose the device within the cover or envelope with the open bottom end and zippered closure configured to fasten to seal the device inside the cover so that the cover acts as a barrier between the device and external environment. The cover is transparent and allows a user to view content displayed by the touchscreen and the rear layer allows the use of the camera while the cover encloses the device.

In this manner, the protective cover or sleeve of the present invention accomplishes all of the foregoing objectives and provides users with an improved protective covering for cell phones, tablets, portable devices and other electronics. The covering utilizes a transparent plastic surface with a zippered closure at the base to secure a device inside the covering or sleeve. The covering allows individuals to store their device inside the covering, while in use and not in use, to maintain protection against external elements, bacteria, and other pathogens.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a touch sensitive protective cover or sleeve for enclosing a handheld electronic or other portable device. The protective cover further includes a first or front layer configured to cover the touchscreen of the device, and a rear layer configured to cover rear surface of the device. The front layer and rear layer are integrally attached together along two side edges, a top edge, and a bottom edge. The front layer and the rear layer are releasably attached at bottom ends or edges thereof. The bottom ends or edges have a zippered or other sealable closure for releasably fastening or sealing the cover over the electronic/portable device. The cover or sleeve is configured to slide over the device to enclose the device within the enclosure with the open bottom end and zippered or sealable closure being configured to fasten and seal the device inside the cover. The cover acts as a barrier between the device and external environment.

In yet another embodiment, the cover enables an individual to use the touchscreen of the electronic device by touching and making gestures on the front layer.

In yet another embodiment, the cover is made of a transparent material allowing a user to view content displayed on the electronic device.

In yet another embodiment, a transparent protective covering made of thin plastic film for cell phones, tablets, and other electronics and portable devices is disclosed. The covering includes a transparent front layer capable of confirming content displayed on the touchscreen during operation, while the covering encloses the device. The rear layer may be transparent or may have transparent areas that are capable of allowing use of the rear camera while the covering continues to enclose the remainder of the device. The thin plastic film is capable of allowing a user to operate the touchscreen, while the covering encloses the device. The covering has a zippered or rib and channel closure at the base to secure the device inside the covering. Alternatively, the sleeve or closure may have a flap that is flipped over the rear of the covering to seal the sleeve. The envelope flap may have an adhesive seal to hold the flap in its sealed position, yet allows the individual to easily open the flap and remove the device from the protective sleeve.

In yet another embodiment, the covering is re-usable and can be wiped with any cleaning solution.

In yet another embodiment, the covering is disposable, recyclable and/or made from recycled material.

In yet another embodiment, a method of keeping the handheld electronic device clean and sanitary without applying harsh chemicals or moisture to the device is described. The method includes the steps of providing a protective cover. The cover includes a multipurpose bag, sleeve or envelope configured to have a pre-determined size to slide on the device to enclose the device within the sleeve or envelope. The cover further has a zippered closure or flap at one end of the sleeve to secure the device inside the cover. The zippered closure is unfastened to open the base and the cover is slid over the device through the open base. The device is enclosed inside the cover and the closure is fastened to secure the device inside the cover.

In yet another embodiment, the method further includes the steps of unfastening a portion of the base to create an opening to insert a charging cable to charge the device while the cover encloses the device. The device is operated using the touchscreen by making gestures on a portion of the sleeve covering the touchscreen while the cover encloses the device.

In yet a further embodiment, the protective sleeve is provided with one or more of an anti-static coating, anti-bacterial, anti-fungal, anti-microbial and/or combinations thereof.

In a further embodiment, a protective sleeve is provided that has a front panel and a back panel with a first longitudinal side and a second longitudinal side. First and second transverse end edges are provided with one of the first and transverse end edges forming an opening the width at least equal to a device to be inserted in the protective sleeve. The other of the first and second transverse end edges are provided with an opening sized and configured to receive a jack for a charging cord or headphones.

In a further embodiment, a method of making a protective sleeve is provided and includes the steps of accessing a database having a number of dimensions for different size electronic devices. Selecting one of the available dimensions. Choosing a closing option for the protective sleeve. Adding one or more coatings to the protective sleeve. Selecting a color and other personalization features. Positioning one or more gripping surfaces to an exterior of the sleeve; and shipping the sleeve to an end user.

In yet another embodiment, a combination protective film covering and electronic device is disclosed and includes a protective covering film placed over an electronic device.

Numerous benefits and advantages of this invention will become apparent to those skilled in the art to which it pertains upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the protective covering of the present invention for a cell phone, tablet, or other electronic and portable device in accordance with the disclosed architecture;

FIG. 2 illustrates a perspective view of one potential embodiment of a process of enclosing a smartphone inside the protective covering of the present invention in accordance with the disclosed architecture;

FIG. 3 illustrates a rear perspective view of the smartphone enclosed in one potential embodiment of the protective covering of the present invention in accordance with the disclosed architecture;

FIG. 4 illustrates a perspective view of an individual using the touchscreen of an electronic device enclosed inside one potential embodiment of the protective cover of the present invention in accordance with the disclosed architecture;

FIG. 5 illustrates a perspective view of another potential embodiment of the protective cover of the present invention for enclosing and protecting a handheld wireless computing device in accordance with the disclosed architecture;

FIG. 6A illustrates a side perspective view of a further potential embodiment of the protective sleeve of the present invention in accordance with the disclosed architecture;

FIG. 6B illustrates a rear perspective view of a further potential embodiment of the protective sleeve of the present invention in accordance with the disclosed architecture; and

FIG. 7 illustrates a block diagram of a potential method of making a protective sleeve of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved protective covering or sleeve for cell phones, tablets, and other electronics and portable devices. There is also a long-felt need in the art for a multipurpose covering or protective sleeve for handheld electronic devices and other portable devices that prevents germs from touching the surface of the electronic devices. Additionally, there is a long-felt need in the art for a cover that protects handheld electronics and other portable devices from germs while allowing individuals to use the device. Moreover, there is a long-felt need in the art for an improved protective covering that eliminates the requirement of applying harsh cleaning chemicals to and/or exposing the device to moisture for cleaning. Further, there is a long-felt need in the art for a protective cover that completely encloses a handheld electronic device for keeping the device clean and sanitary. Furthermore, there is a long-felt need in the art for a protective cover for cell phones, tablets, and other electronics and portable devices that prevents transmission of pathogens during sharing of electronics between individuals. Finally, there is a long-felt need in the art for a protective covering that is at least partially transparent, allows use of electronics and other portable devices, and protects the electronics against external elements, bacteria, and more.

The present invention, in one exemplary embodiment, is a novel protection covering having at least one panel being at least partially transparent of thin plastic for cell phones, tablets, and other electronics. The covering includes at least a partially transparent front layer that enables a user to view content displayed on the touchscreen when a device operates while the covering encloses the device. A rear layer or back panel which may be colored, transparent, partially transparent, translucent, and/or opaque and capable of allowing use of the rear camera through an opening if the back panel is other than transparent, while the covering encloses the device. The thin plastic is capable of allowing a user to operate a touchscreen while the covering at least substantially, encloses the device. The covering has a zippered or other closure at the base to secure the device within the covering.

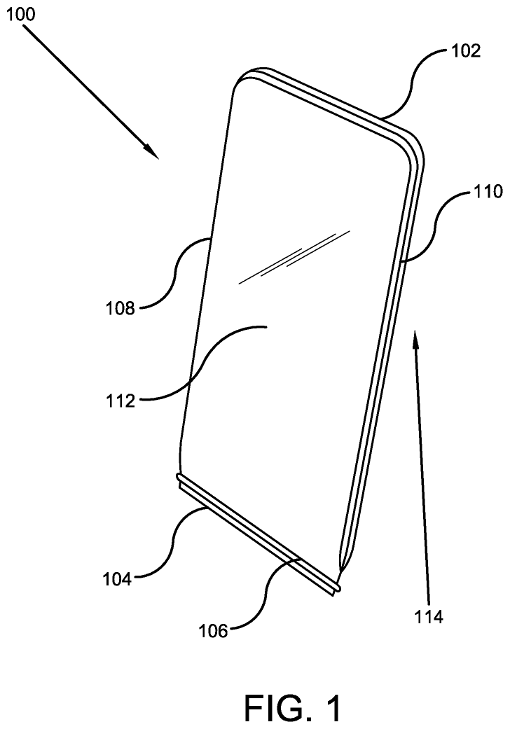

Referring initially to the drawings, FIG. 1 illustrates a perspective view of one potential embodiment of the protective covering 100 of the present invention for cell phones, tablets, and other electronics in accordance with the disclosed specification. The protective covering 100 of the present invention is configured to completely enclose a handheld electronic device (including smartphones, tablets, and other portable devices) for preventing germs, bacteria, and other pathogens as well as fingers of a user from touching the surfaces of the device and leaving behind fingerprints, dirt and debris. More specifically, the covering 100 is in the form of a strong and sturdy bag that has a top closed end 102 and an open bottom end 104. The bottom end 104 has a fastener 106 disposed thereon for fastening and closing the open bottom end 104 as per preference of a user. In another embodiment, a flap may be provided to close the protective envelope. The fastener 106 in the preferred embodiment, is a zipper but can be any other fastener, like a sliding fastener, rib and channel closure, or any other suitable closure known in the art. The covering 100 has a pair of side or longitudinal edges 108, 110 wherein each side edge adjoins the front layer 112 and the rear layer 114. As a result, the cover 100 has three closed ends 102, 108, 110 and an open end 104. Transverse ends 102 and 104 are used to complete the protective envelope. It is worth noting that cover 100 is not limited in use to only phones, tablets and other portable devices. Rather, the cover 100 also has potential applicability at banks, restaurants, schools, hospitals, airports, on military equipment and any other screen.

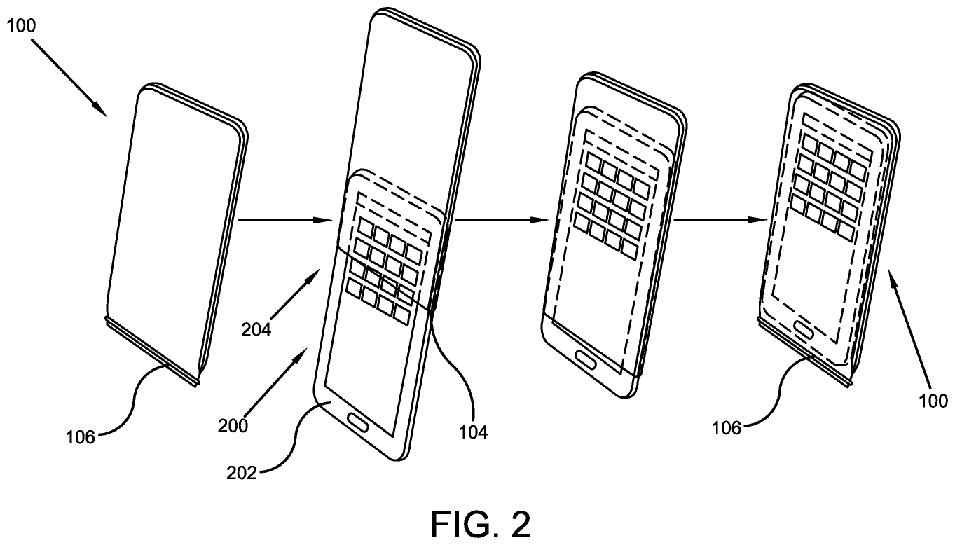

The cover 100 is configured to slide over a handheld electronic device, as displayed in FIG. 2, through the open bottom end or transverse end edge 104 to enclose the device for creating a physical barrier which prevents physical access to the surfaces of the device and/or phone. At least the front panel 112 of the cover 100 is made of an optically transparent, flexible and touch sensitive material like polyethylene terephthalate glycol (PETG), polyolefin, polypropylene, cyclic olefin copolymer, optically clear polyester, or polycarbonate which allows use of a touchscreen of the device while the cover 100 encloses the device. The film may have a thickness ranging from 0.005 to 10 mils with about 0.10 to 5 mils being preferred. The cover 100 may also comprise an elastic back portion or side panel to provide for a snug fit and to accommodate a finger grip device.

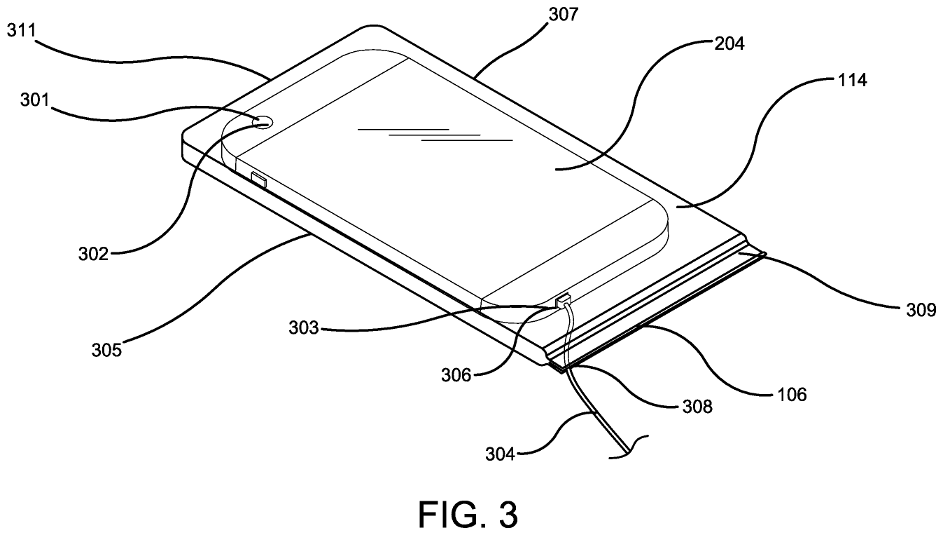

The cover 100 comes in various sizes to accommodate handheld electronic devices of various sizes and configurations. Further, the rear layer or back panel 114 covers the rear surface of a device and allows the use of the rear camera without any obstruction. Further, sensors, such as proximity sensor, and total radiated power (TRP) of the electronic device are also not affected due to use of the covering 100. The cover 100 may have an anti-microbial coating for preventing pathogen collection. Other coatings may include an anti-static coating to prevent the film from sticking to the device. Where the back panel 114 is made from a colored, opaque material or where the film is not optically clear, an opening 301 (see FIG. 3) may be provided to enable use of the camera.

The cover 100 can come in a package of 10, 20, 50, 100 or more covers of a single size or various sizes to meet requirements of various sized devices. The fastener 106 at bottom end 104 can be unfastened slightly to accommodate a charging cable to charge the device as disclosed in FIG. 3. Alternatively, a small opening may be provided on the bottom transverse edge to accommodate the jack without having to open the envelope.

The cover 100 is preferably waterproof or at least water-resistant, scratch resistant and tear resistant. Further, the cover 100 can be wiped to clean using any chemical and thus prevents the touchscreen of an enclosed device from damage. Alternatively, the cover 100 can be configured to be disposable and recyclable and is useful in cases where an electronic device is shared among many people. The cover 100 does not have any metallic component which would affect electromagnetic specifications of the enclosed device and further provides protection from scratches and dirt when the device is placed on any surface.

FIG. 2 illustrates a process of enclosing a smartphone inside the protective covering 100 of the present invention in accordance with the disclosed specification. The smartphone 200 shown in the present embodiment is an exemplary electronic device and any other device like a tablet, PDA or other portable device can be covered by the envelope or sleeve 100. As illustrated, initially, the cover 100 is in a closed state with the fastener or closure 106 in a closed state. For sliding the cover 100 over the phone 200 to protect the phone 200 from physical touch and pathogens, the zipper or closure 106 is unfastened to open the bottom end 104. The cover 100 is then slid over the phone 200 through the open bottom end 104 and the cover 100 is pulled (or the smartphone is pushed) to enclose the phone 200 inside the cover 100 such that, the front layer or front panel 112 covers the touchscreen 202 and the rear layer or back panel 114 covers the rear surface 204 of the smartphone 200.

The dimensions of the cover 100 are such that the smartphone 200 is completely enclosed inside the cover 100 and none of the surfaces are directly accessible. Once the phone 200 is enclosed, the zipper or other closure106 is fastened to seal the phone 200 inside the cover.

The optically clear material of the cover 100 allows a user to use the phone or device 200 without having to remove the cover 100. Further, the cover 100 being optically transparent does not obstruct the view of the touchscreen and allows a user to view visual contents and applications provided by an electronic device 200.

For removing the cover 100, the zipper or closure 106 can be unfastened and the phone 200 can be pulled therefrom and as per preferences of a user, the cover 100 can be wiped for reuse or can be disposed of.

FIG. 3 illustrates a rear perspective view of the smartphone 200 enclosed in the protective covering 100 of the present invention in accordance with the disclosed specification. An advantage of the cover 100 is that the cover does not obstruct the use of the rear camera 302 of the phone 200 when the cover 100 is slid over the phone 200, either through use of the optically transparent film or through a hole provided in the film. As illustrated, the rear layer 114 covers the rear surface 204 of the smartphone 200 and the optically transparent color of the cover 100 makes the use of the camera 302 easy and obstruction free. In one embodiment, the rear layer 114 may have a cut out 301 aligning with the position of the camera 302 on the phone 200.

The cover 100 allows the electronic device 200 to be charged using the jack of a conventional charging cable 304. The fastener 106 is slightly opened for enabling insertion of the cable 304 inside the cover 100 and plugged into the charging port 306. For inserting the charging cable 304, the closure 106 is slightly opened to create an opening 308 and the cable 304 is inserted through the opening 308 and plugged into the port 306. Alternatively, the bottom transverse edge may have an opening 303 to allow insertion of the jack. Then, the zippered or other closure 106 is fastened again to close any additional gap created for sealing the phone 200 inside the cover 100. FIG. 3 also provides that the cover 100 has first and second longitudinally extending side edges 305 and 307 and first and second transversely extending end edges 309 and 311.

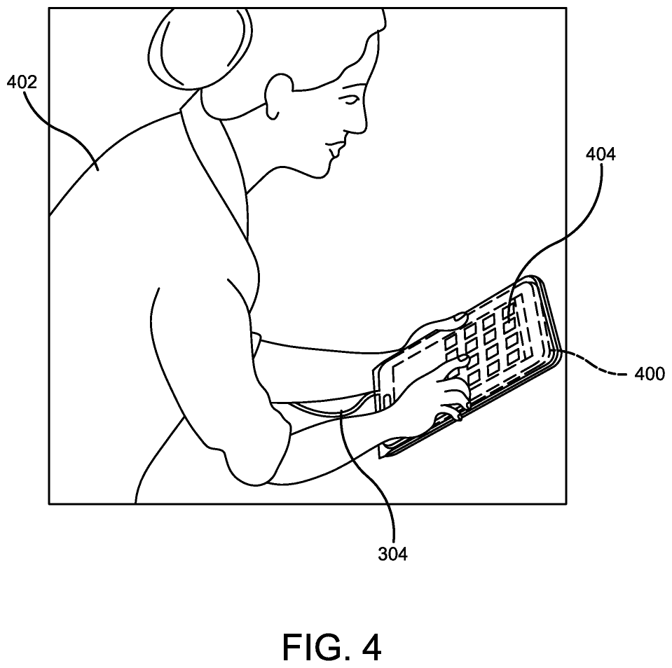

FIG. 4 illustrates an individual using the touchscreen of an electronic device enclosed inside the protective cover 100 in accordance with the disclosed description. The cover 100 allows a user 402 to operate the electronic device 400 such as Apple iPad®, in the present embodiment, without removing the cover 100. The transparent cover 100 enables the user 402 to view the user interface on the touchscreen 404 and allows the user 400 to perform regular operations as performed directly on the touchscreen 404.

The protective cover 100 is disposed between the surface of the device 400 and the individual 402 using the device 400, and thus protects against the transfer of germs from the user 402 to the electronic device 400 or from the device to an individual. Similarly, the pathogens and germs that may have already been present on the device 400 are not contracted by the user 402.

Further, during use of the device 400 while being enclosed within the cover 100, the charging cable 304 can be used for charging the device 400 allowing the individual 402 to use the device 400 in a protected manner while the devices is being charged.

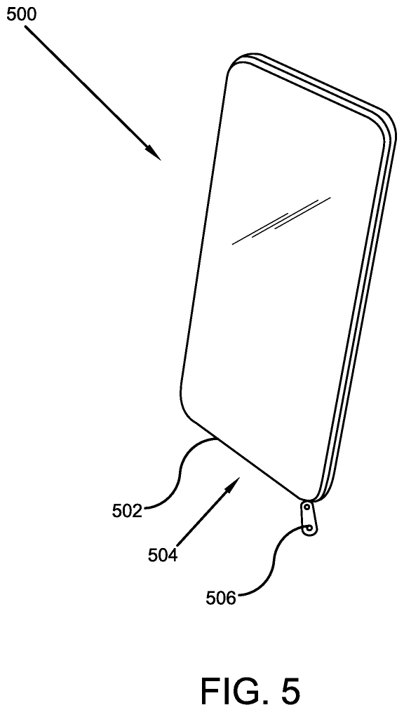

FIG. 5 illustrates a perspective view of another embodiment of the protective cover for enclosing and protecting handheld wireless computing devices in accordance with the disclosed specification. In the present embodiment, the cover 500 is made from flexible, sturdy and touch sensitive material and has a closure fastener 502 at the bottom end 504 along a transverse end edge. The zipper fastener 502 has a hook or pull 506 that can slide for opening and closing the bottom end 504 and helps in sliding the cover 500 over a wireless computing device. The functionality and other characteristics of the cover 500 are the same as of the protective cover 100 of other embodiments.

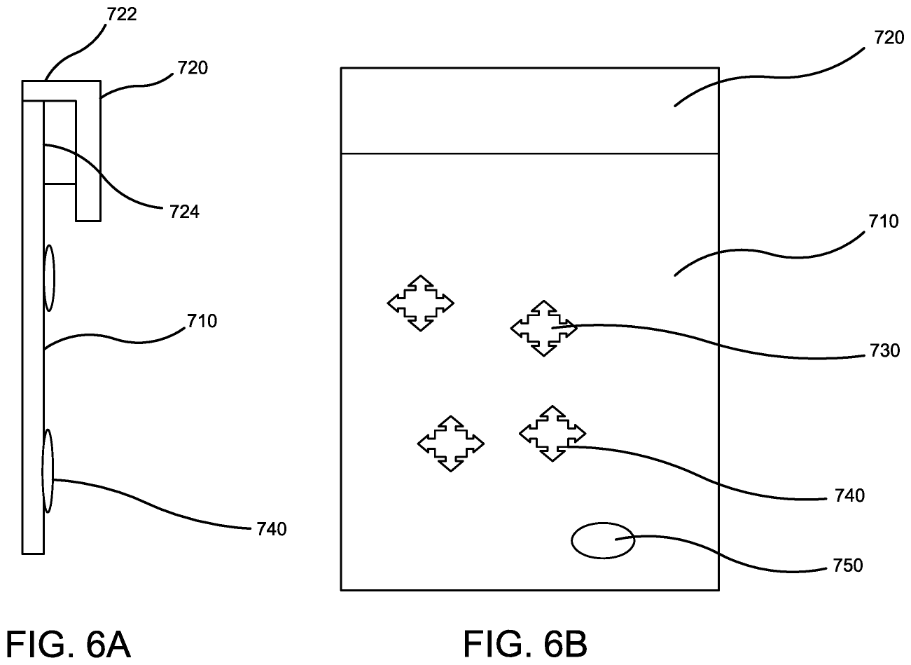

FIG. 6A illustrates a side perspective view of a further potential embodiment of the protective sleeve of the present invention, and FIG. 6B illustrates a rear perspective view of the protective sleeve, wherein the back panel 710 of the cover is shown in a non-transparent configuration so that an individual may personalize the device and choose a color that matches or complements the electronic device or his or her preference. More specifically, the back panel 710 is shown with a flap 720 that is folded over at least a portion of the back panel 710. The flap 720 may be secured in position by a strip of adhesive 724, which may be a removable or repositionable adhesive. A portion of the flap 720 is folded over the top 722. The back panel 710 may be provided with an opening 750 to accommodate the camera of the phone or tablet. As the protective film may be more slippery than the device by itself, tactile elements 730 and 740 may be provided on the back or side panels to help in gripping the phone or other device enclosed within the sleeve. The tactile or gripping elements 730 and 740 maybe of any geometric or fanciful shape and may be any color and can be slightly raised from the surface to aid in grasping a device.

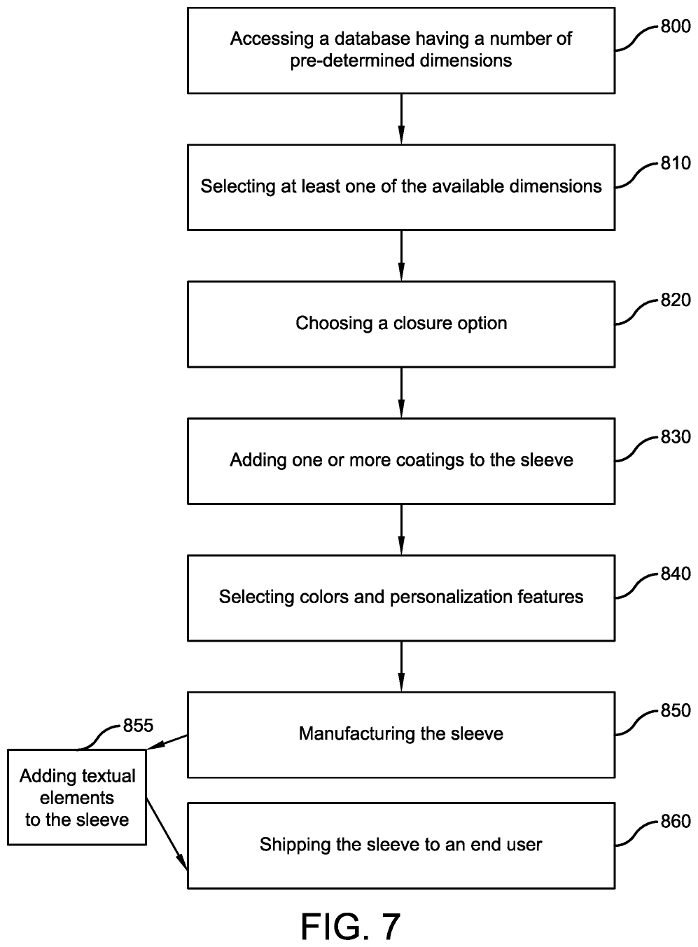

FIG. 7 provides a block diagram of a method of making a protective cover for an electronic or portable device. The method starts at step 800 with a user accessing a database having a number of predetermined dimensions for different sized electronic devices. At step 810, the user selects one of the available dimensions, and a closing option for the protective sleeve at step 820. At step 830, the user adds one or more coatings to the protective sleeve, and selects a color and other personalization features at step 840 before manufacturing the same at 850. At step 855, one or more gripping surfaces can be positioned on an exterior of the sleeve prior to shipping the sleeve to an end user at step 860.

It should be noted that the protective cover is designed to be substantially planar and for maintaining optimal temperature for an enclosed electronic device. The cover may also prevent the enclosed device from physical damage, scratches and may be waterproof or water resistant. A user can operate the enclosed device by touching and making gestures on the cover for direct access to the camera, touchscreen, and other components.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “protective cover”, “handheld electronic device protective covering”, “protective covering”, and “handheld wireless computing device protective covering”, are interchangeable and refer to the handheld electronic device touch sensitive protective covering 100, 500 of the present invention.

Notwithstanding the foregoing, the handheld electronic device touch sensitive protective covering 100, 500 of the present invention can be of any suitable size and configuration as is known in the art without affecting the overall concept of the invention provided that it accomplishes the above-stated objectives. One of ordinary skill in the art will appreciate that the handheld electronic device touch sensitive protective covering 100, 500 as shown in the FIGS. are for illustrative purposes only, and that many other sizes and shapes of the handheld electronic device touch sensitive protective covering 100, 500 are well within the scope of the present disclosure. Although the dimensions of the handheld electronic device touch sensitive protective covering 100, 500 are important design parameters for user convenience, the handheld electronic device touch sensitive protective covering 100, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective sleeve for an electronic or portable device, the protective sleeve comprising:
a front panel;
a back panel;
a first longitudinal side attached to the front and back panels;
a second longitudinal side attached to the front and back panels;
a first transverse end edge; and
a second transverse end edge, wherein at least one of the first and second transverse end edges form an opening having a width at least equal to the electronic or portable device to be inserted into the protective sleeve, and further wherein at least one of the front and back panels is comprised of a transparent material.

2. The protective sleeve for an electronic or portable device as recited in claim 1, wherein another of the first and second transverse end edges is provided with an opening sized and configured to receive a jack for a charging cord or headphone.

3. The protective sleeve for an electronic or portable device as recited in claim 1, wherein the front panel is comprised of a transparent material.

4. The protective sleeve for an electronic or portable device as recited in claim 1, wherein the back panel is comprised of a select one of a colored material, an opaque material, a transparent material, a partially transparent material, or a translucent material.

5. The protective sleeve for an electronic or portable device as recited in claim 4, wherein the back panel includes an opening sized and configured for a camera.

6. The protective sleeve for an electronic or portable device as recited in claim 1 further comprising a closure for the opening.

7. The protective sleeve for an electronic or portable device as recited in claim 6, wherein the closure is one of a zipper or a rib and channel closure.

8. The protective sleeve for an electronic or portable device as recited in claim 1, wherein the protective sleeve is comprised of a select one of a polyethylene terephthalate glycol (PETG), a polyolefin, a polypropylene, a cyclic olefin copolymer, an optically clear polyester or a polycarbonate.

9. The protective sleeve for an electronic or portable device as recited in claim 8, wherein the protective sleeve has a thickness ranging from 0.005 to 10 mils.

10. The protective sleeve for an electronic or portable device as recited in claim 8, wherein the thickness ranges from 0.10 to 5 mils.

11. The protective sleeve for an electronic or portable device as recited in claim 1 further comprising at least one tactile or gripping element positioned on the back panel.

12. The protective sleeve for an electronic or portable device as recited in claim 1 further comprising at least one of an anti-static coating, an anti-bacterial coating, an anti-fungal coating or an anti-microbial coating.

13. A method of manufacturing and personalizing a protective covering, the method comprising the steps of:
accessing a database having a plurality of dimensions for different sized electronic devices;
selecting one of the plurality of dimensions for different sized electronic devices;
choosing a closing option for the protective covering;
selecting a color and other personalization features for the protective covering;
manufacturing the protective covering; and
shipping the protective covering to an end user.

14. The method of manufacturing and personalizing a protective covering as recited in claim 13 further comprising a step of adding one or more coatings to the protective covering after the step of selecting.

15. The method of manufacturing and personalizing a protective covering as recited in claim 13 further comprising a step of positioning one or more gripping surfaces to an exterior of the protective covering after the step of selecting.

16. The method of manufacturing and personalizing a protective covering as recited in claim 14, wherein the one or more coatings are selected from a group consisting of an anti-static coating, an anti-bacterial coating, an anti-fungal coating, an anti-microbial coating or a combination thereof.

17. The method of manufacturing and personalizing a protective covering as recited in claim 13, wherein the protective covering is comprised of at last one of a polyethylene terephthalate glycol (PETG), a polyolefin, a polypropylene, a cyclic olefin copolymer, an optically clear polyester or a polycarbonate.

18. The method of manufacturing and personalizing a protective covering as recited in claim 17, wherein the protective covering has a thickness ranging between 0.005 to 10 mils.

19. A combination protective sleeve and electronic device comprising:
an electronic device having a front, a back and a touch panel position on the front;
a protective sleeve having a front panel and a rear panel, wherein at least the front panel is comprised of an optically clear film;
an opening provided on one end of the protective sleeve along a transverse end edge, wherein the opening is sized and configured to receive the electronic device;
a closure for the opening; and
an area on the rear panel to allow a camera on the electronic device to be used without interference.

20. The combination protective sleeve and electronic device as recited in claim 19, wherein the protective sleeve further comprises at least one coating selected from a group consisting of an anti-static coating, an anti-bacterial coating, an anti-fungal coating, an anti-microbial coating or a combination thereof.
